(19) United States
(12) Patent Application Publication
(10) Pub. No.: US 2005/0192018 A1
(43) Pub. Date: Sep. 1, 2005

(54) Wireless data communication apparatus and method capable of checking receipt and status

(76) Inventor: Kyung-hun Jang, Suwon-city (KR)

Correspondence Address: LEE, STERBA & MORSE, P.C., SUITE 2000, 1101 WILSON BOULEVARD, ARLINGTON, VA, 22209, US

(21) Appl. No.: 11/099,445

(22) Filed: Apr. 6, 2005

Related U.S. Application Data
(63) Continuation-in-part of application No. 10/218,031, filed on Aug. 14, 2002, now abandoned.

(30) Foreign Application Priority Data
Aug. 14, 2001 (KR) 10-2001-0049034
Nov. 30, 2004 (KR) 10-2004-0099168

(51) Int. Cl. H04Q 7/20

(52) U.S. Cl. 455/450

(57) ABSTRACT

A wireless data communication apparatus and method capable of checking whether stations receive data from an access point and states of the stations include using a wireless transmission frame which includes an uplink period, a contention period, a receipt confirmation period, and a receiving state period. The receipt confirmation period is a period in which a subcarrier channel set is activated when the station successfully receives data from the access point, and the receiving state period is a period in which the subcarrier channel set is activated when the station can successfully receive data to be transmitted again from the access point.

### CROSS-REFERENCE TO RELATED APPLICATIONS

The present application is a continuation-in-part application of and claims priority under 35 U.S.C. § 120 to co-pending U.S. patent application Ser. No. 10/218,031 filed Aug. 14, 2002, which claims priority under 35 U.S.C. § 119 to Korean Patent Application No. 2001-49034, filed on Aug. 14, 2001, and further claims priority to Korean Patent Application No. 10-2004-0099168, filed on Nov. 30, 2004, all of which are incorporated by reference herein in their entirety.

### BACKGROUND OF THE INVENTION

1. Field of the Invention

The present invention relates to wireless data communication. More particularly, the present invention relates to a wireless transmission frame used in wireless data communication, e.g., Orthogonal Frequency Division Multiplex (OFDM), and a wireless data communication apparatus and method for performing communication using the wireless transmission frame.

2. Description of the Related Art

FIG. 1 illustrates a conventional transmission frame structure, for use in a wireless data system, which includes a broadcast period, a downlink period, an uplink period and a contention period.

Referring to FIG. 1, an access point distributes and allocates an uplink resource to each station connected to the access point. Each station transmits data to the access point using the allocated uplink resource. The access point can also transmit data to each station via the downlink period.

In general, a wireless data communication system transmits data less reliably than a cable channel due to the characteristics of the wireless channel. Therefore, unlike in a cable channel, the wireless data communication system requires a retransmission mechanism to improve the reliability of data transmission in a data link layer. The retransmission mechanism uses an acknowledgment (ACK) message or ACK timeout. Throughout this disclosure, the ACK message will be referred to as an ACK.

FIG. 2 illustrates a conventional method of generating an ACK to be transmitted from a station to an access point. Referring to FIG. 2, the access point transmits data DATA to the station via a downlink period of a frame N. When the station satisfactorily receives the data DATA transmitted via the downlink period, it sends an ACK confirming receipt of the data DATA to the access point. At this time, when an uplink resource has already been allocated to the station via a broadcast period of the frame N, the station transmits the ACK together with the data DATA to the access point, as illustrated in FIG. 2.

However, since a data stream is asymmetrical in most cases, it is highly probable that the station is not allocated with an uplink resource at the time when the station sends the ACK to the access point.

FIG. 3 illustrates a conventional process of sending an ACK to an access point when an uplink resource is not allocated to a station. Referring to FIG. 3, when the station is not allocated with the uplink resource in a frame N, the station requests, via a contention period of the frame N, the access point to allocate an uplink resource, which will be used to transmit an ACK, in a next frame N+1. In other words, the station sends a bandwidth request to the access point. When the access point allocates the uplink resources, i.e., sends a bandwidth allocate, to the station via a broadcast period of the frame N+1, the station sends an ACK to the access point via an uplink period of the frame N+1.

The access point resends data DATA to the station when the bandwidth request or the ACK, which is to be transmitted from the station to the access point, is lost during wireless interface or when the station does not successfully receive the data DATA since the data DATA is lost in transmission.

FIG. 4 illustrates a conventional process of resending data DATA when the data DATA is lost in transmission. Referring to FIG. 4, when the data DATA transmitted from an access point to a station is lost in a frame N, the station fails to completely receive the data DATA. Thus, the station does not send an ACK to the access point. When the access point does not receive an ACK from the station within the ACK timeout, the access point concludes that the station failed to normally receive the data DATA, and resends the data DATA in a next frame N+m.

However, since the ACK timeout is a relatively long time, it will take time for the access point to recognize a failure in transmission of the data DATA. In other words, it is difficult to immediately resend the data DATA. For this reason, some conventional methods suggest omitting a retransmission mechanism for real-time data service, or to set the ACK timeout to be short, but this is insufficient to completely solve the above problem.

When a station receiving services from an access point goes out of a service area in which the access point can provide the services, it is impossible to exchange data between the station and the access point. This communication failure also occurs when supply of power to the station is stopped, e.g., due to a limited battery capacity of the station. In general, when a station exits a service area or loses power, the station cannot so inform an access point. Therefore, the access point may allocate transmission resources to the station, thereby causing unnecessary consumption of resources. In other words, when the access point transmits, via a downlink period, data to a station that is out of the service area, the access station cannot receive an ACK from the station. Thus, the access point continuously resends the data to the station.

To solve this problem, various methods have been introduced. For example, the access point may allocate a dedicated control channel to each station, periodically receive, from each station, a message regarding whether each station is connected to the access point, and periodically determine whether each station is within the service area. However, the allocation of a dedicated control channel to each station causes unnecessary consumption of resources. Alternatively, the access point may periodically check whether a particular station intends to receive data and whether the station sends an ACK to the access point within the ACK timeout. However, this also causes unnecessary consumption of resources during the ACK timeout, since the ACK timeout is a relative long time period.

### SUMMARY OF THE INVENTION

The present invention is therefore directed to a wireless data communication apparatus and method, which substantially overcome one or more of the problems due to the limitations and disadvantages of the related art.

It is therefore a feature of an embodiment of the present invention to provide a wireless data communication apparatus for performing wireless data communication while allowing an access point to determine whether a station receives data transmitted from the access point, and to check the status of the station, i.e., whether the station can receive data transmitted from the access point, thereby effectively using resources.

It is another feature of an embodiment of the present invention to provide a wireless data communication method for performing wireless data communications while allowing an access point to determine whether a station received data transmitted from the access point, and to check the status of the station, i.e., whether the station can receive data transmitted from the access point, thereby effectively using resources.

At least one of the above and other features and advantages may be realized by providing a wireless data communication apparatus which performs wireless data communications between an access point and at least one station. The wireless data communications is performed using a wireless transmission frame that includes an uplink period, a contention period, a receipt confirmation period, and a receiving state period. The receipt confirmation period is a period in which a subcarrier channel set is activated when the station successfully receives data from the access point, and the receiving state period is a period in which the subcarrier channel set is activated when the station can successfully receive data to be transmitted again from the access point.

The receipt confirmation period and the receiving state period may each have at least one signal indicating a state of the subcarrier channel set. The subcarrier channel set may have more than one subcarrier channel.

At least one of the above and other features and advantages may be realized by providing wireless data communication apparatus which performs wireless data communications using a wireless transmission frame which includes an uplink period, a contention period, a receipt confirmation period, and a receiving state period, the wireless data communication apparatus including an access point and a station which requests access to the access point. The access point allocates a subcarrier channel set to be used in the receipt confirmation period and the receiving state period of the wireless transmission frame and transmits data to the station. The station determines whether the subcarrier channel set will be activated in the receipt confirmation period according to whether the station successfully receives the data transmitted from the access point and determines whether the subcarrier channel set will be activated in the receiving state period according to whether the station can receive data to be transmitted again from the access point. The access point transmits data in a next frame according to a state of the subcarrier channel set.

In the next frame, the access point transmits new data to the station if the subcarrier channel set is activated in the receipt confirmation period. In the next frame, the access point retransmits data to the station if the subcarrier channel set is activated in the receiving state period. In the next frame, the access point does not transmit data to the station if the subcarrier channel set is not activated in either the receipt confirmation period or the receiving state period.

The station does not activate the subcarrier channel set in the receiving state period when the station is out of a service area of the access point or has no power. The station activates the subcarrier channel set in the receiving state period when an error occurs during demodulation of packets in the data or when the station detects a signal with a level equal to or greater than a reference level.

At least one of the above and other features and advantages may be realized by providing a wireless data communication method performed between an access point and at least one station using a wireless transmission frame which includes a downlink period, an uplink period, a receipt confirmation period, a receiving state period, and a contention period, the wireless data communication method including allocating a subcarrier channel set to a station that requests access to the access point and transmitting wireless data from the access point to the station in the downlink period, the subcarrier channel set being used in the receipt confirmation period and the receiving state period of the wireless transmission frame, maintaining the subcarrier channel set as deactivated in the receipt confirmation period if the station does not successfully receive the transmitted data, determining whether the station can successfully receive data from the access point when the station does not successfully receive the transmitted data, activating the subcarrier channel set in the receiving state period if the station can successfully receive data from the access point, and determining whether the subcarrier channel set is activated in one of the receipt confirmation period and the receiving state period.

The method may include, after the allocating, determining whether data transmitted from the access point to the station are successfully received, activating the subcarrier channel set in the receipt confirmation period if the station successfully receives the data, and proceeding to determining whether the subcarrier channel set is activated.

The method may include transmitting new data from the access point to the station in a downlink period of a next frame if the subcarrier channel set is activated in the receipt confirmation period, retransmitting data already transmitted from the access point to the station if the subcarrier channel set is activated in the receiving state period, or not transmitting data from the access point to the station if the subcarrier channel set is maintained as deactivated in the receiving state period.

At least one of the above and other features and advantages may be realized by providing a recording medium having recorded thereon a computer executable program code for the wireless data communication method.

### BRIEF DESCRIPTION OF THE DRAWINGS

The above and other aspects and features of the present invention will become more apparent to those of ordinary skill in the art by describing in detail exemplary embodiments thereof with reference to the attached drawings in which:

FIG. 1 illustrates a structure of a conventional transmission frame for use in wireless data communication;

FIG. 2 illustrates a view for explaining a conventional method of generating an ACK to be transmitted from a station to an access point;

FIG. 3 illustrates a view for explaining a conventional process of sending an ACK to an access point when an uplink resource is not allocated to a station;

FIG. 4 illustrates a view for explaining a conventional process of resending data when the data is lost in a wireless interface;

FIG. 5 illustrates a structure of a wireless transmission frame according to an embodiment of the present invention;

FIG. 6 is a schematic block diagram of a wireless data communication apparatus that performs wireless data communication using the wireless transmission frame of FIG. 5, according to an embodiment of the present invention;

FIG. 7 is a flowchart illustrating a wireless data communication method performed by the wireless data communication apparatus of FIG. 6, according to an embodiment of the present invention; and

FIG. 8 illustrates a view for explaining a process of sending data to each station according to an embodiment of the present invention, performed by the wireless data communication method of FIG. 7.

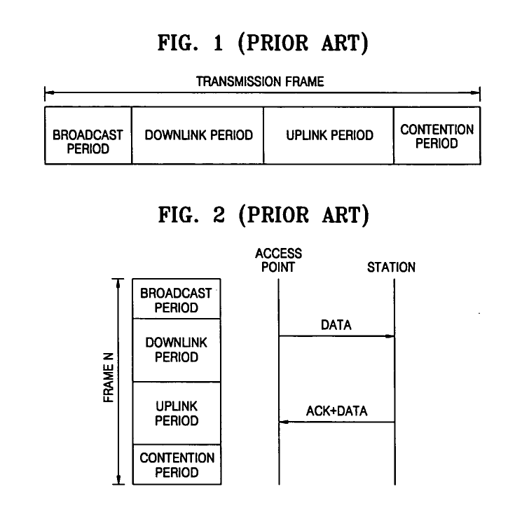

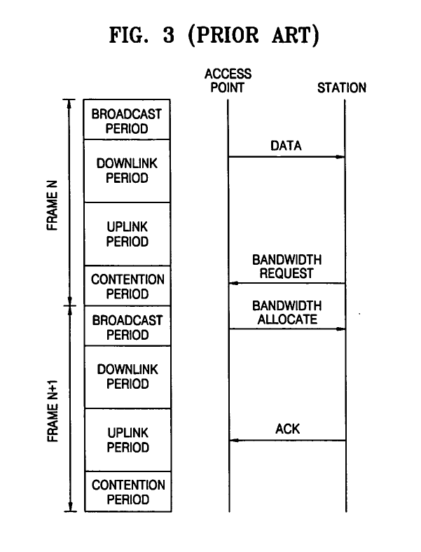

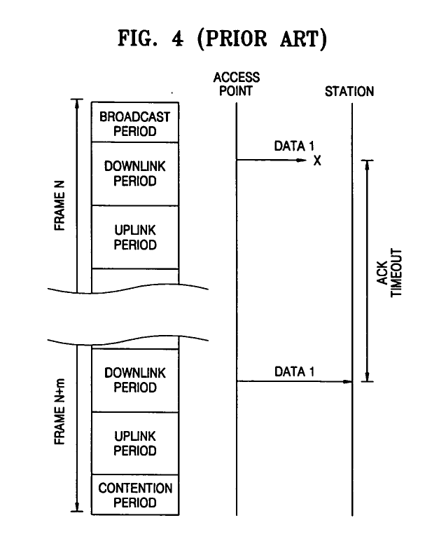

### DETAILED DESCRIPTION OF THE INVENTION

Hereinafter, the structure and operation of a wireless data communication apparatus and a wireless data communication method performed in the apparatus of the present invention will now be described with reference to the accompanying drawings.

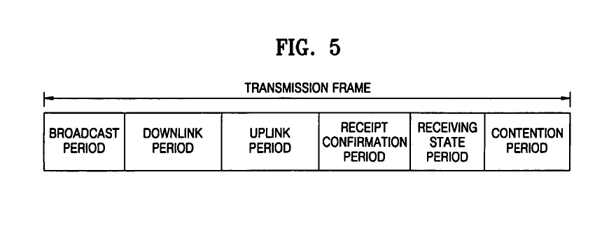

FIG. 5 illustrates a structure of a wireless transmission frame according to an embodiment of the present invention. The wireless transmission frame includes a broadcast period, a downlink period, an uplink period, a receipt confirmation period, a receiving state period, and a contention period.

Referring to FIG. 5, the receipt confirmation period and the receiving state period are present between the uplink period and the contention period of the wireless transmission frame. Here, the receipt confirmation period is a period during which a subcarrier channel set is activated when a station (not shown) satisfactorily receives data transmitted from an access point (not shown). The receiving state period is a period during which the subcarrier channel set is activated when a station can receive data to be retransmitted from the access point. In general, an Orthogonal Frequency Division Multiplex (OFDM) mode has a plurality of subcarrier channels in a carrier wave. For instance, a Wireless Local Area Network (WLAN) includes 52 subcarrier channels, and a Broadband Wireless Access (BWA) includes 512 or 1024 subcarrier channels. The access point allocates a subcarrier channel set to each station, which is then used during the receipt confirmation period and the receiving state period.

The access point can determine whether the station actually receives data by checking whether the subcarrier channel set is activated in the receipt confirmation period in the same as the frame through which the access point transmitted the data to the station. The access point can also determine whether the station can receive the data to be retransmitted from the access point by checking whether the subcarrier channel set is activated in the receiving state period in the same as the frame through which the access point transmitted the data to the station. In other words, the station can indirectly present the reason(s) why it cannot receive the data transmitted from the access point by deactivating or activating the subcarrier channel set in the receiving state period. Each of the receipt confirmation period and the receiving state period has at least one signal indicting their respective states.

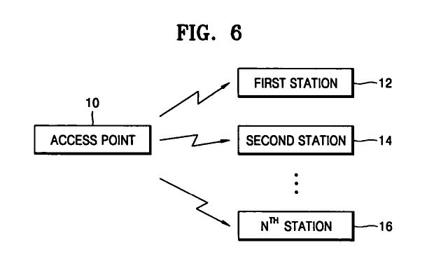

FIG. 6 is a schematic block diagram of a wireless data communication apparatus that performs wireless data communication using the wireless transmission frame of FIG. 5. Referring to FIG. 6, the wireless data communication apparatus includes an access point 10 and first through n^{th} stations 12 through 16, where n is a positive integer equal to or greater than one.

Referring to FIGS. 5 and 6, when the access point 10 receives a network access request from a station, the access point 10 allocates a subcarrier channel set to the station. The subcarrier channel set is to be used in a receipt confirmation period and a receiving state period. The access point 10 preferably allocates the subcarrier channel set to a station that requests real-time data services. During allocation, all of the subcarrier channel sets are deactivated.

After the allocation of the subcarrier channel set to the station requesting the network access, the access point 10 transmits, via a downlink period, wireless data to the station connected to the access point 10 via the network among the first through n^{th} stations 12 through 16.

When each of the first through n^{th} stations 12 through 16 accesses the access point 10, the access point 10 allocates a subcarrier channel set to each station. When data transmitted from the access point 10 in the downlink period is successfully received, each of the first through n^{th} stations 12 through 16 activates the allocated subcarrier channel set in the receipt confirmation period. However, when stations of the first through n^{th} stations 12 through 16 do not successfully receive data transmitted from the access point 10, they do not activate the allocated subcarrier channel set in the receipt confirmation period. A station which does not activate the allocated subcarrier channel set in the receipt confirmation period determines whether it can successfully receive data from the access point 10, and activates the subcarrier channel set in the receiving state period according to the result of analysis. In other words, when the station among the first through n^{th} stations 12 through 16 can successfully receive the data to be retransmitted from the access point 10, the station activates the allocated subcarrier channel set in the receiving state period. However, if the station among the first through n^{th} stations 12 through 16 is not capable of successfully receiving data from the access point 10, the station does not activate the allocated subcarrier channel set in the receiving state period, i.e., the allocated subcarrier channel set remains deactivated.

For example, when a station is out of a service area of the access point 10 or has no power, the station determines that it cannot successfully receive data to be retransmitted from the access point 10. Thus, the subcarrier channel set of this station remains deactivated in the receiving state period. In contrast, when a station generates an error during demodulation of packets or senses a signal with a level equal to or greater than a reference level, but does not successfully receive data from the access point 10, the station determines that it can successfully receive data to be retransmitted from the access point 10. Thus, this station activates the allocated subcarrier channel set in the receiving state period. The error during demodulation of packets may be a Cyclic Redundancy Check (CRC) error.

For each of the first through n^{th} stations 12 through 16, the access point 10 checks whether subcarrier channels belonging to the subcarrier channel set allocated for the receipt confirmation period and the receiving state period are activated. In the next frame, the access point 10 transmits new data, retransmits data that was transmitted in the previous frame or transmits no data to each station according to the result of checking. The access point 10 may operate according to the state of the subcarrier channel set in the receipt confirmation period and/or the receiving state period, as shown in Table 1.

TABLE 1

| ACK | STA | Operation of Access Point |
|---|---|---|
| 1 | X | The access point 10 perceives that a station successfully |
| | | receives packets, and thus, retransmission of data is not |
| | | necessary. |
| 0 | 1 | The access point 10 perceives that the station did not |
| | | successfully receive the packets, but it can successfully |
| | | receive data to be transmitted again. |
| 0 | 0 | The access point 10 perceives that the station did not |
| | | successfully receive the packets and cannot receive data |
| | | to be transmitted again. |

In Table 1, ACK is the receipt confirmation period, for which “0” is a state where the subcarrier channel set is deactivated and “1” is a state where the subcarrier channel set is activated. In Table 1, STA is the receiving state period, for which “0” is a state where the subcarrier channel set is deactivated, “1” is a state where the subcarrier channel set is activated, and “X” is a state where the subcarrier channel set can be activated or deactivated.

Referring to Table 1, when the receipt confirmation period ACK and the receiving state period STA correspond to the states “1” and “X”, respectively, the access point 10 transmits new data in the next frame to the station. When the receipt confirmation period ACK and the receiving state period STA correspond to the states “0” and “1”, respectively, the access point 10 retransmits the previous data in the next frame to the station. When the receipt confirmation period ACK and the receiving state period STA correspond to the state “0”, the access point 10 does not transmit data in the next frame to the station.

Additionally, a subcarrier channel of the subcarrier channel set activated in the receipt confirmation period ACK or the receiving state period STA may be lost in a wireless communications network due to multi-path fading. Accordingly, the access point 10 may allocate a plurality of subcarrier channels, rather than just one subcarrier channel, in a subcarrier channel set to each station to cope with problems when the subcarrier channel of the subcarrier channel set, which are used for the receipt confirmation period ACK and the receiving state period STA, are lost. For example, when each station is allocated with a subcarrier channel set having three (3) subcarrier channels to be used in the receipt confirmation period ACK, the access point 10 considers each station as successfully receiving data as long as at least one (1) of the three (3) subcarrier channels is activated. Similarly, when each station is allocated with a subcarrier channel set having three (3) subcarrier channels to be used in the receiving state period STA, the access point 10 considers that each station can successfully receive data to be transmitted again as long as at least one (1) of the three (3) subcarrier channels is activated.

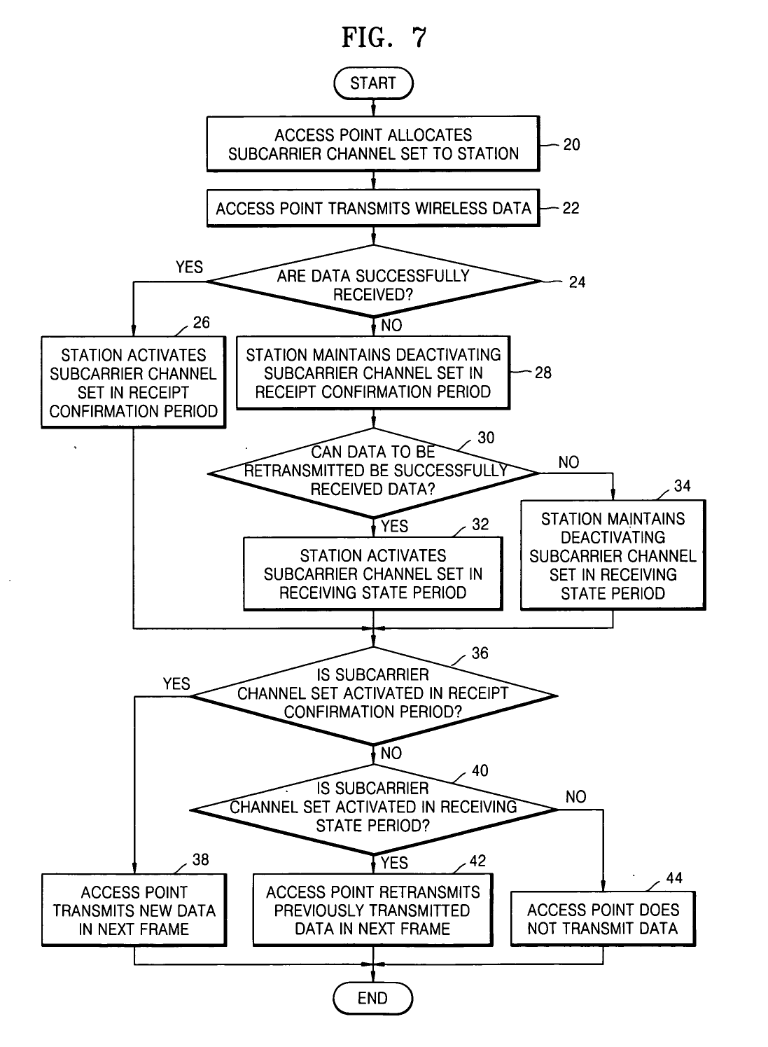

FIG. 7 is a flowchart illustrating a wireless data communication method according to an embodiment of the present invention. Referring to FIG. 7, an access point allocates a subcarrier channel set and transmits data (operations 20 and 22). Next, the access point determines whether the data is successfully received, and activates the subcarrier channel set accordingly (operations 24 through 34). Next, the access point operates according to whether the subcarrier channel set is activated in the receipt confirmation period ACK and the receiving state period STA (operations 36 through 44).

More specifically, if the station determines data are successfully received in operation 24, the station activities the subcarrier channel set in operation 26 in the receipt confirmation period. If not, the station maintains the subcarrier channel set as deactivated in the receipt confirmation period in operation 28 and determines whether retransmitted data can be successfully received in operation 30. If it can, then the station activates the subcarrier channel set in operation 32 in the receiving state period. If not, the station maintains the subcarrier channel set as deactivated in the receiving state period in operation 34.

Next, if the access point determines that the subcarrier channel set is activated in the receipt confirmation period in operation 36, the access point transmits new data in the next frame in operation 38. If not, the access point determines whether the subcarrier channel is set in the receiving state period in operation 40. If it is, then the access point retransmits the previously transmitted data in the next frame in operation 42. If not, the access point does not transmit data in operation 44.

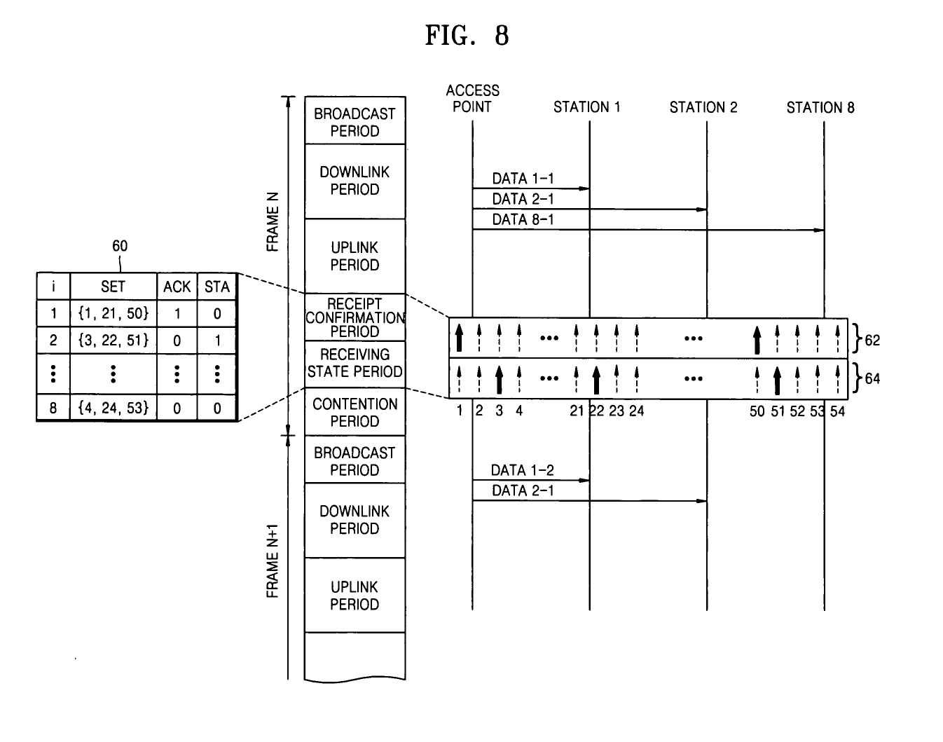

FIG. 8 is a diagram illustrating a process of sending data to each station, according to an embodiment of the present invention, by the wireless data communication method of FIG. 7. In FIG. 8, states of subcarrier channels in a receipt confirmation period signal 62 and a receiving state period signal 64 of the corresponding period shown in FIG. 5, are illustrated for a plurality of stations. Within the receipt confirmation period and the receiving state period signals 62 and 64, dotted lines represent a deactivated subcarrier channel and bold solid lines represent an activated subcarrier channel.

In the process of FIG. 8, it is assumed that a wireless data communication is a WLAN communication, the number of stations that can access the access point via a network is eight (n=8), shown as a first station STATION1, a second station STATION2, through an eighth station STATION8 connected to the access point. Referring to a mapping table 60 of FIG. 8, first, twenty-first, and fiftieth subcarrier channels are allocated as a subcarrier channel set SET for the first station (i=1). Third, twenty-second, and fifty-first subcarrier channels are allocated as a subcarrier channel set SET for the second station (i=2). Fourth, twenty-fourth, and fifty-third subcarrier channels are allocated as a subcarrier channel set SET for the eighth station (i=8).

A wireless data communications method according to the present invention will now be described in greater detail with reference to FIGS. 7 and 8.

First, the access point 10 allocates a subcarrier channel set to be used in the receipt confirmation period and the receiving state period to each of stations that request access to the access point via a network (operation 20). At this time, the access point 10 may allocate a plurality of subcarrier channels as the subcarrier channel set of each station in case some of the subcarrier channels are lost in the receipt confirmation period.

Next, the access point 10 transmits wireless data to the stations connected via the network (operation 22). Referring to FIG. 8, the access point 10 transmits wireless data DATA 1-1, DATA 2-1, . . . DATA 8-1 to the first through eighth stations via a downlink period of a frame N. Then, each of the first through eighth stations extracts and receives the corresponding wireless data only among wireless data DATA 1-1, DATA 2-1, . . . DATA 8-1 transmitted from the access point, respectively.

The stations connected to the access point 10 via the network determine whether they successfully received the data from the access point (operation 24). A station that successfully receives the data activates the subcarrier channel set allocated in operation 20 in a receipt confirmation period of the frame N (operation 26). In contrast, a station that does not successfully receive the data transmitted from the access point 10 maintains the subcarrier channel set allocated in operation 20 as deactivated in the receipt confirmation period of the frame N (operation 28).

In the specific example shown in FIG. 8, the first station successfully receives data DATA 1-1 transmitted from the access point 10. However, the second and eighth stations do not successfully receive the data DATA 2-1 and DATA 8-1 transmitted from the access point, respectively. Therefore, the first station activates the first, twenty-first, and fiftieth subcarrier channels of the subcarrier channel set within the in the receipt confirmation period signal 62 of the frame N, i.e., the receipt confirmation period sets the state to “1” (ACK=1). However, the second station does not receive the data DATA 2-1, and thus maintains the third, twenty-second, and fifty-first subcarrier channels as deactivated, in the receipt confirmation period of the frame N, i.e., the receipt confirmation period maintains the state at “0” (ACK=0). Likewise, the eighth station does not receive the data DATA 8-1, and thus maintains the fourth, twenty-fourth, and fifty-third subcarrier channels as deactivated in the receipt confirmation period of the frame N, i.e., the receipt confirmation period maintains the state at “0” (ACK=0).

The station that does not successfully receive the wireless data transmitted from the access point 10, i.e., it maintains the subcarrier channels in the receipt confirmation period as deactivated, determines whether it can successfully receive the data to be transmitted again from the access point 10 (operation 30). For example, the station determines whether it can successfully receive the data to be transmitted again from the access point by checking whether it is out of a service region of the access point 10, its power is off, an error occured during demodulation of packets, or a signal with a level equal to or greater than a reference level is detected.

If the station determines that it can successfully receive the data to be transmitted again from the access point 10, the station activates the subcarrier channel set in the receiving state period (operation 32). In this case, the receiving state period sets the state to “1” (STA=1). If the station determines that it cannot successfully receive the data to be transmitted again from the access point 10, the station maintains the subcarrier channel set in the receiving state period as deactivated (operation 34). In this case, the receiving state period is maintained at “0” (STA=0).

For the particular example in FIG. 8, since the second station determines that it can successfully receive data transmitted again from the access point 10, the second station activates the third, twenty-second, and fifty-first subcarrier channels of the subcarrier channel set within the receiving state period signal 64 of the frame N, i.e., the receiving state period STA is set to “1” (operation 32). However, since the eighth station determines that it cannot successfully receive the data transmitted again from the access point 10, the eighth station maintains the fourth, twenty-fourth, and fifty-third subcarrier channels of the subcarrier channel set as deactivated within the receiving state period signal 64 of the frame N, i.e., the receiving state period STA is maintained at “0” (operation 34).

In the wireless data communication method of FIG. 7, operation 36 is performed after operation 26.

After operation 32 or 34, the access point 10 determines whether the subcarrier channel set is activated in the receipt confirmation period and the receiving state period of the frame N (operations 36 and 40). Specifically, the access point 10 determines whether the subcarrier channel set is activated in the receipt confirmation period ACK (operation 36). If it is determined that the subcarrier channel set is activated in the receipt confirmation period ACK, the access point 10 transmits new data to the station, which activates the subcarrier channel set in the receipt confirmation period and transmits the activated subcarrier channel set in the receipt confirmation period signal 62 to the access point 10, via a downlink period of a next frame N+1 (operation 38).

If it is determined that the subcarrier channel set is not activated in the receipt confirmation period ACK, the access point determines whether the subcarrier channel set is activated in the receiving state period STA (operation 40). If it is determined that the subcarrier channel set is activated in the receiving state period STA, the access point 10 retransmits the data, which was transmitted in the downlink period of the frame N in operation 22, to the station which activates the subcarrier channel set in the receiving state period STA, in the downlink period of the next frame N+1 (operation 42). However, when it is determined that the subcarrier channel set is not activated in the receiving state period STA, the access point 10 does not transmit data to the station that has a deactivated subcarrier channel set in the receiving state period STA (operation 44).

In the specific example shown in FIG. 8, the access point 10 determines whether the subcarrier channels in the receipt confirmation period signal 62 are activated in the receipt confirmation period of the frame N and whether the subcarrier channels in the receiving state period signal 64 are activated in the receiving state period. Specifically, the access point 10 determines that the first and fiftieth subcarrier channels in the receipt confirmation period signal 62 are activated. The activated first and fiftieth subcarrier channels are subcarrier channels for the first station. Even if the twenty-first subcarrier channel allocated to the first station is lost in transmission, the access point 10 considers the first station to have satisfactorily received the data DATA 1-1, since at least one of the first, twenty-second, and the fiftieth subcarrier channels is activated. Accordingly, the access point 10 sends the first station new data DATA 1-2 in the downlink period of the next frame N+1.

Also, the access point 10 perceives that all the third, twenty-second, and fifty-first subcarrier channels allocated to the second station, and all the fourth, twenty-fourth, and fifty-third subcarrier channels allocated to the eighth station are deactivated in the receipt confirmation period signal 62. In this case, the access point 10 considers that the second and eighth stations that have the deactivated subcarrier channels did not successfully receive the wireless data. Thus, the access point 10 checks whether the subcarrier channels allocated to the second and eighth stations have been activated or remain deactivated in the receiving state period signal 64. Since all the third, twenty-second, and the fifty-first subcarrier channels allocated to the second station are activated in the receiving state period STA, the access point 10 sends the data DATA 2-1, which was transmitted in the frame N to the second station, in the downlink period of the next frame N+1 to the second station again. However, since all the fourth, twenty-fourth, and fifty-third subcarrier channels allocated to the eighth station are deactivated in the receiving state period STA, the access point 10 transmits neither the data DATA 8-1, which was transmitted in the frame N to the eighth station, nor new data DATA 8-2 to the eighth station in the downlink period of the next frame N+1.

The present invention can be embodied as a computer readable code in a computer readable recording medium. Here, the computer readable recording medium may be any recording apparatus capable of storing data that can be read by a computer system. For example, the computer readable recording medium may be a read-only memory (ROM), a random access memory (RAM), a compact disc (CD)-ROM, a magnetic tape, a floppy disk, an optical data storage device, and so on. Also, the computer readable recording medium may be implemented in the pattern of a carrier wave that transmits data via the Internet, for example. The computer readable recording medium can be distributed among computer systems that are interconnected through a network, and the present invention may be stored and implemented as a computer readable code in the distributed system.

As described above, in a wireless data communication apparatus and method according to the present invention, an access point can determine not only whether a station receives data transmitted from the access point, but also the state of a station, which does not receive the data, by checking whether a subcarrier channel set is allocated in a receiving state period of the frame in the same as a frame that was used to transmit the data to the station. Next, the access point transmits new data to the station, retransmits the previous data to the station or does not transmit any data to the station according to the result of the determination. Accordingly, it is possible to prevent data from being sent again to station that cannot receive data since it is out of a service area of the access point, for example, and exclude the station from the stations that will receive services from the access point, thereby minimizing consumption of resources and effectively using the resources. Also, it is possible to immediately determine whether a station is out of the service area of the access point through the receiving state period.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1. A wireless data communication apparatus which performs wireless data communications between an access point and at least one station, wherein the wireless data communication apparatus performs the wireless data communications using a wireless transmission frame comprising an uplink period, a contention period, a receipt confirmation period, and a receiving state period, wherein
the receipt confirmation period is a period in which a subcarrier channel set is activated when the station successfully receives data from the access point, and
the receiving state period is a period in which the subcarrier channel set is activated when the station can successfully receive data to be transmitted again from the access point.

2. The wireless data communication apparatus as claimed in claim 1, wherein the receipt confirmation period and the receiving state period each have at least one signal indicating a state of the subcarrier channel set.

3. A wireless data communication apparatus which performs wireless data communications using a wireless transmission frame which includes an uplink period, a contention period, a receipt confirmation period, and a receiving state period, the wireless data communication apparatus comprising:
an access point; and
a station which requests access to the access point, the access point allocating a subcarrier channel set and transmitting data to the station, the subcarrier channel set being used in the receipt confirmation period and the receiving state period of the wireless transmission frame,
the station determining whether the subcarrier channel set will be activated in the receipt confirmation period according to whether the station successfully receives the data transmitted from the access point and determining whether the subcarrier channel set will be activated in the receiving state period according to whether the station can receive data to be transmitted again from the access point,
the access point transmitting data in a next frame according to a state of the subcarrier channel set.

4. The wireless data communication apparatus as claimed in claim 3, wherein, in the next frame, the access point transmits new data to the station if the subcarrier channel set is activated in the receipt confirmation period.

5. The wireless data communication apparatus as claimed in claim 3, wherein, in the next frame, the access point retransmits data to the station if the subcarrier channel set is activated in the receiving state period.

6. The wireless data communication apparatus as claimed in claim 3, wherein, in the next frame, the access point does not transmit data to the station if the subcarrier channel set is not activated in either the receipt confirmation period or the receiving state period.

7. The wireless data communication apparatus as claimed in claim 3, wherein the station does not activate the subcarrier channel set in the receiving state period when the station is out of a service area of the access point.

8. The wireless data communication apparatus as claimed in claim 3, wherein the station does not activate the subcarrier channel set in the receiving state period when the station has no power.

9. The wireless data communication apparatus as claimed in claim 3, wherein the station activates the subcarrier channel set in the receiving state period when an error occurs during demodulation of packets in the data.

10. The wireless data communication apparatus as claimed in claim 3, wherein the station activates the subcarrier channel set in the receiving state period when the station detects a signal with a level equal to or greater than a reference level.

11. A wireless data communication method performed between an access point and at least one station using a wireless transmission frame which includes a downlink period, an uplink period, a receipt confirmation period, a receiving state period, and a contention period, the wireless data communication method comprising:
(a) allocating a subcarrier channel set to a station that requests access to the access point and transmitting wireless data from the access point to the station in the downlink period, the subcarrier channel set being used in the receipt confirmation period and the receiving state period of the wireless transmission frame;
(b) maintaining the subcarrier channel set as deactivated in the receipt confirmation period if the station does not successfully receive the transmitted data;
(c) determining whether the station can successfully receive data from the access point when the station does not successfully receive the transmitted data;
(d) activating the subcarrier channel set in the receiving state period if the station can successfully receive data from the access point; and
(e) determining whether the subcarrier channel set is activated in one of the receipt confirmation period and the receiving state period.

12. The wireless data communication method as claimed in claim 11, further comprising:
(f) after (a), determining whether data transmitted from the access point to the station are successfully received; and
(g) activating the subcarrier channel set in the receipt confirmation period if the station successfully receives the data, and proceeding to (e).

13. The wireless data communication method as claimed in claim 11, further comprising:
transmitting new data from the access point to the station in a downlink period of a next frame if the subcarrier channel set is activated in the receipt confirmation period.

14. The wireless data communication method as claimed in claim 11, further comprising:
retransmitting data already transmitted in (a) from the access point to the station if the subcarrier channel set is activated in the receiving state period.

15. The wireless data communication method as claimed in claim 11, further comprising not transmitting data from the access point to the station if the subcarrier channel set is maintained as deactivated in the receiving state period.

16. A recording medium having recorded thereon a computer executable program code for the wireless data communication method as claimed in claim 11.
